(19) United States
(12) Patent Application Publication
(10) Pub. No.: US 2012/0213152 A1
(43) Pub. Date: Aug. 23, 2012

(54) Methods and Systems for Reducing Service Delays in IMS Systems

(75) Inventors: Cormac HEGARTY, BROMMA (SE); Afshin ABTIN, Karlstad (SE); Juan Manuel FERNANDEZ GALMES, Getafe (Madrid) (ES)

(73) Assignee: TELEFONAKTIEBOLAGET L M ERICSSON (PUBL), Stockholm (SE)

(21) Appl. No.: 13/397,053

(22) Filed: Feb. 15, 2012

Related U.S. Application Data
(60) Provisional application No. 61/443,886, filed on Feb. 17, 2011.

(51) Int. Cl. H04W 4/00

(52) U.S. Cl. 370/328

(57) ABSTRACT

Methods and systems are provided to reduce service delays in wireless communications networks. A method for gathering information associated with a user equipment (UE) at a node which is a part of a mobile communication network, the method includes: receiving a message at the node; and prefetching information associated with the UE upon receipt of the message, wherein prefetching includes transmitting a request for the information associated with the UE and receiving a response to the request for the information associated with the UE.

### RELATED APPLICATIONS

The present application is related to, and claims priority from, the U.S. Provisional Application Ser. No. 61/443,886, entitled “Methods and Systems for Reducing Service Delays in IMS Systems,” filed on Feb. 17, 2011 and the disclosure of which is incorporated herein by reference.

### TECHNICAL FIELD

The present invention relates generally to telecommunications systems, and in particular, to methods, systems, devices and software associated with service delays in wireless communications networks.

### BACKGROUND

Radiocommunication networks were originally developed primarily to provide voice services over circuit-switched networks. The introduction of packet-switched bearers in, for example, the so-called 2.5G and 3G networks enabled network operators to provide data services as well as voice services. Eventually, network architectures will likely evolve toward all Internet Protocol (IP) networks which provide both voice and data services. However, network operators have a substantial investment in existing infrastructures and would, therefore, typically prefer to migrate gradually to all IP network architectures in order to allow them to extract sufficient value from their investment in existing infrastructures. Also to provide the capabilities needed to support next generation radiocommunication applications, while at the same time using legacy infrastructure, network operators could deploy hybrid networks wherein a next generation radiocommunication system is overlaid onto an existing circuit-switched or packet-switched network as a first step in the transition to an all IP-based network. Alternatively, a radiocommunication system can evolve from one generation to the next while still providing backward compatibility for legacy equipment.

One example of such an evolved network is based upon the Universal Mobile Telephone System (UMTS) which is an existing third generation (3G) radiocommunication system that is evolving into High Speed Packet Access (HSPA) technology. Yet another alternative is the introduction of a new air interface technology within the UMTS framework, e.g., the so-called Long Term Evolution (LTE) technology. Target performance goals for LTE systems include, for example, support for 200 active calls per 5 MHz cell and sub 5 ms latency for small IP packets. Each new generation, or partial generation, of mobile communication systems add complexity and abilities to mobile communication systems and this can be expected to continue with either enhancements to proposed systems or completely new systems in the future.

Another relatively recent evolution involves the introduction of the IP Multimedia Subsystem (IMS) architecture. IMS was developed in order to, among other things, ease the integration of IP networks with existing voice and data networks.

As is common when implementing most new, large and complex systems, provisions should be made for a time when legacy systems co-exist with the newly introduced systems. As, for example, packet-switched (PS) IMS/LTE systems are introduced, it is anticipated that they will need to interact with, for example, legacy circuit-switched (CS) communication systems, e.g., Global System for Mobile Communications (GSM) radiocommunication systems.

One example of how to handle various aspects of such interactions can be found in the standards document 3rd Generation Partnership Project (3GPP) Technical Specification (TS) 23.292 which, among other things, describes architectural requirements for delivery of consistent services to a user regardless of the attached access type (e.g., CS or PS). As part of this document, IMS Centralized Services (ICS) are described, wherein a user's services are migrated from a CS network to an IMS network. According to this 3GPP standards document, IMS will be the network serving the user as a single service engine, meaning that originating and terminating calls need to visit the IMS network.

This may, however, introduce unacceptable delays in the provision of various services particularly when, for example, nodes associated with the IMS need to obtain information from legacy network nodes in order to provide a particular service.

### SUMMARY

According to an embodiment, a method for setting up a connection comprises: receiving, at a node, a location query message associated with the connection that is being setup, pre-fetching, by the node and in response to receipt of the location query message, information associated with the connection, and, subsequent to the pre-fetching, receiving a request for the information. The node can be a Home Subscriber Server (HSS). The information which is pre-fetched can be associated with a Terminating Access Domain Selection (T-ADS) function, a Network Location (NetLoc) or other function. In addition, the method can include storing or caching the pre-fetched information by the node, e.g., fetching information prior to when it would normally be fetched. The node can check to see if stored or cached information associated with a subscriber whose connection is being setup is valid and then selectively pre-fetch that information again, or not. This will ensure that the call set-up time will be improved compared to typical processing of a terminating call.

According to an exemplary embodiment, there is a method for gathering information associated with a user equipment (UE) at a node which is a part of a mobile communication network. The method includes: receiving a message at the node; and prefetching information associated with the UE upon receipt of the message, wherein prefetching includes transmitting a request for the information associated with the UE and receiving a response to the request for the information associated with the UE.

According to an exemplary embodiment, there is a communications node for gathering information associated with a user equipment (UE) which is a part of a mobile communication network. The communications node includes: an interface configured to receive a message at the node; and a processor configured to prefetch information associated with the UE upon receipt of the message, wherein to prefetch includes transmitting a request for the information associated with the UE and receiving a response to the request for the information associated with the UE.

According to other embodiments, systems or devices used to perform the methods are provided. For example, a node can include a processor which is configured to perform the above-described method steps.

### BRIEF DESCRIPTION OF THE DRAWINGS

The exemplary embodiments described below will be understood, in conjunction with the drawings submitted herewith in which:

FIG. 1 illustrates an architecture associated with embodiments including an enhanced Mobile Switching Center (MSC);

FIG. 2 illustrates an architecture associated with embodiments including a non-enhanced MSC;

FIG. 3 shows a conventional call process;

FIG. 4 is a flowchart associated with an embodiment;

FIG. 5 shows the structure in which Terminating-Access Domain Selection (T-ADS) information is formatted;

FIG. 6 illustrates a call process according to an embodiment;

FIG. 7 depicts obtaining Cell ID information;

FIG. 8 is a block diagram of an exemplary node in which embodiments can be implemented; and

FIG. 9 is a flowchart of a method according to an embodiment.

### DETAILED DESCRIPTION

The following detailed description of the exemplary embodiments refers to the accompanying drawings. The same reference numbers in different drawings identify the same or similar elements. Also, the following detailed description does not limit the invention. The following embodiments are discussed, for simplicity, with regard to the terminology and structure of exemplary systems. However, the embodiments to be discussed next are not limited to such exemplary systems but may be applied to other telecommunications systems.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification are not necessarily all referring to the same embodiment. Further, the particular features, structures or characteristics may be combined in any suitable manner in one or more embodiments.

One scenario in which the afore-described service delay issue is foreseen to arise is when Internet Protocol Multimedia Subsystem (IMS) Centralized Services (ICS) is introduced in alignment with the start of voice over Long Term Evolution (VoLTE) where Multimedia Telephony Service (MMTel)/IMS is the recommended service engine. This scenario means, however, that during early phases of IMS and VoLTE deployments, both VoLTE and circuit-switched (CS) access will co-exist due to a lack of full LTE coverage. The users in such a network will be served by CS and LTE, however IMS will be used as service engine. This will introduce delays in the provision of various services in the network, for example, the connection of calls using Terminating-Access Domain Selection (T-ADS) and the provision of a CellId by the Network Provided Location (NetLoc) service, both of which will be described in more detail below.

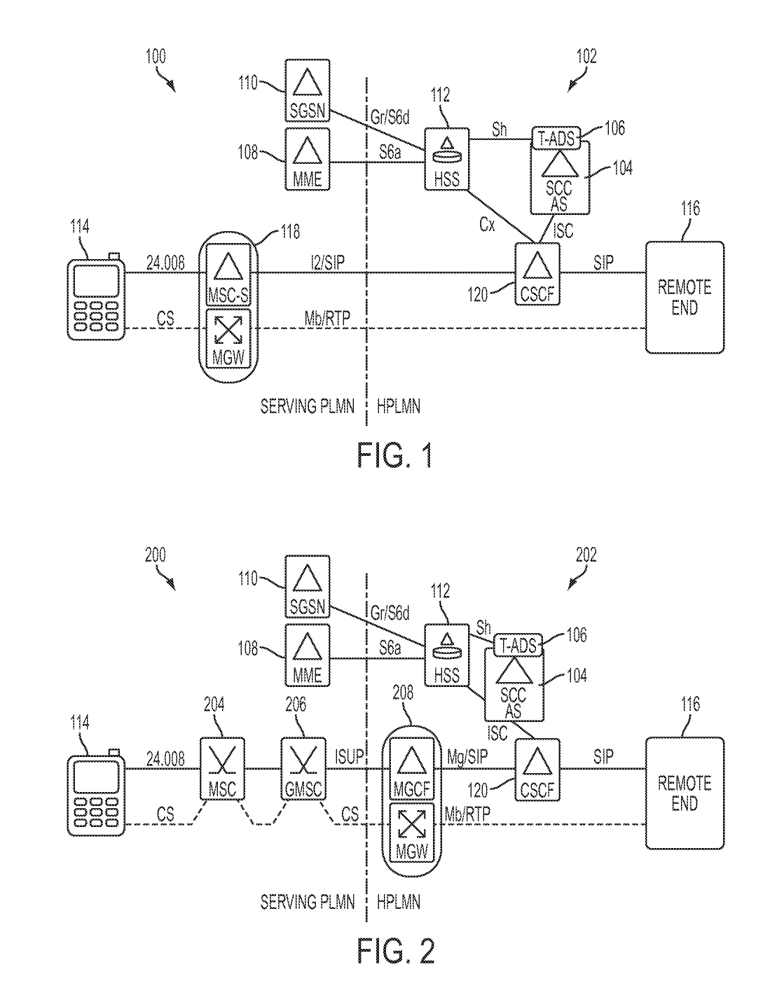

To first provide some context for this discussion, FIG. 1 illustrates various nodes associated with a serving Public Land Mobile Network (PLMN) 100 which provides for CS access and a home PLMN 102 which includes an IMS architecture. It will be appreciated by those skilled in the art that only a few, relevant IMS nodes are illustrated in FIG. 1 including a Service Centralization and Continuity Application Server (SCC AS) 104 which provides, among other functions, a Terminating-Access Domain Selection (T-ADS) function 106. The T-ADS function operates to, among other things, (a) be aware of a currently used access type for a particular connection, i.e., packet-switched (PS) or CS (to forward terminating calls to user), (b) check for IMS voice over PS support and RAT (Radio Access Type) type in the serving Mobility Management Entity (MME) 108 and/or Serving GPRS Support Node (SGSN) 110, and (c) query, for all terminating calls for registered contacts (if registered via PS), the current serving nodes (via Home Subscriber Service (HSS) 112) for IMS voice over PS support and RAT type. The T-ADS 106 obtains the aforementioned information (PS support & RAT) via the reference point Sh. The HSS 112 obtains this information via the reference points Sha to the Evolved Packet Core (EPC) node MME 108 or via Gr/S6d to SGSN 110. Although shown in FIG. 1 as an HSS, node 112 may also include Home Location Register (HLR) functionality as described below and is sometimes referred to as an HLR/HSS.

It will be appreciated by those skilled in the art that the procedures performed by T-ADS 106 per se are further described in the 3^{rd} Generation Partnership Project (3GPP) standards documents 3GPP TS 23.292, 23.221, 23.401, the disclosures of which are incorporated here by reference. Conventionally, these T-ADS procedures are triggered by the SCC AS 104 in IMS based on an Sh query.

FIG. 1 also depicts an originating user equipment (UE) 114 and a remote end of the connection 116. Omitted from the figure, among other things, are the access point nodes, e.g., eNodeBs. However FIG. 1 also illustrates the registrar nodes associated with the various access domains, i.e., a mobile switching center (MSC) 118 in the serving PLMN 100 and a call session control function (CSCF) 120 in the home PLMN 102. The CSCF 120 can include a proxy CSCF (P-CSCF), serving CSCF (S-CSCF) and/or interrogating CSCF (I-CSCF). In the example of FIG. 1, the MSC 118 is an “enhanced” MSC server (MSC-S) having ICS capabilities, meaning that it has the capability to register users in IMS.

FIG. 2 depicts a similar set of nodes associated with a serving PLMN 200 and home PLMN 202, wherein the same reference numerals used in FIG. 1 are reused in FIG. 2 to identify the same or similar nodes. However in FIG. 2, the MSC 204 is not enhanced and, therefore, does not have the capability to register users in IMS. Accordingly, and as an example, a CS terminating call will be routed through MSC 204 and on to Gateway MSC (GMSC) 206 which routes the call through protocol conversion entities 208 in the control and media planes.

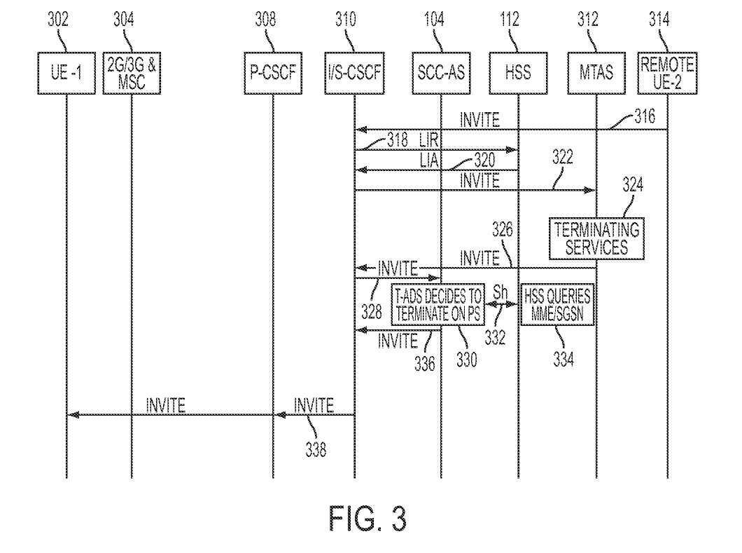

However, the T-ADS function 106 as currently described does not adequately consider delays in set up times for establishing a terminating call. For all terminating VoLTE subscribers that do not have an active or held call and have a PS registration, it will be necessary to query HSS 112 to obtain information on their IMS voice over PS support and RAT type. The HSS 112 must in turn query the MME 108 or SGSN 110. Even though a user may not be registered over CS, it is still necessary to query the HSS 112 because the user may have moved from LTE to a non-ICS enhanced MSC 204. Furthermore the LTE contact is not deregistered when moving to CS and not re-registered when moving from CS to LTE. In a typical process, the mechanism for obtaining the information needed by the T-ADS function 106 from the HSS/HLR 112, i.e., the PS support and RAT information, is triggered toward the end of the processing of the terminating call, i.e., by the SCC AS 104 which is the last (or one of the last) application servers triggered in the processing of the terminating call. Thus the call setup process typically has to wait for a query to the HSS 112, a subsequent query to the MME 108 or SGSN 110, and responses to return. As the number of potential terminating VoLTE subscribers may be hundreds of thousands and in the initial phase of VoLTE, LTE coverage may be “patchy”, this will significantly impact terminating call setup times. This conventional call process is shown in FIG. 3.

Initially, for the conventional call process shown in FIG. 3, remote UE2 318, transmits an invite message 316 which is received by an I-CSCF or an S-CSCF 310. The CSCF 310 then transmits a lookup information request (LIR) message 318 to the HSS 112. The HSS 112 then transmits a location information answer (LIA) message 320 back to the CSCF 310. The CSCF 310 then transmits an invite message 322 to the MT AS 312 which performs terminating services 324. The MT AS 312 then transmits an invite message 326 back to the CSCF 310 which in turn sends an invite message 328 to the SCC-AS 104. The T-ADS decides to terminate on PS as shown in block 330 which triggers the SCC AS 104 to communicate with the HSS 112 over the Sh reference 332. The HSS 112 then performs a fetching process by querying the MME/SGSN for the T-ADS information as shown in block 334. After receiving this information the SCC AS 104 sends an invite message 336 to the CSCF 310. CSCF 310 then sends an invite message 338 to UE1 302 via a P-SCSF 308, a MSC 304 and the communication network, e.g., a 2G or a 3G communication network.

According to embodiments described herein, an “off-line”, pre-emptive fetch and caching of information can be performed by the HSS 112 to the MME 108 or SGSN 110 (or GGSN). This pre-emptive fetching is also described herein as “prefetching” as the information is obtained earlier than it would otherwise normally be obtained as shown in FIG. 3. The triggering of this pre-emptive fetch can, for example be based on existing signaling mechanisms in the core network. In this way, the system can acquire the information needed by the T-ADS function 106 in parallel with the other processes which are being performed to set-up the terminating call, to thereby reduce connection setup times.

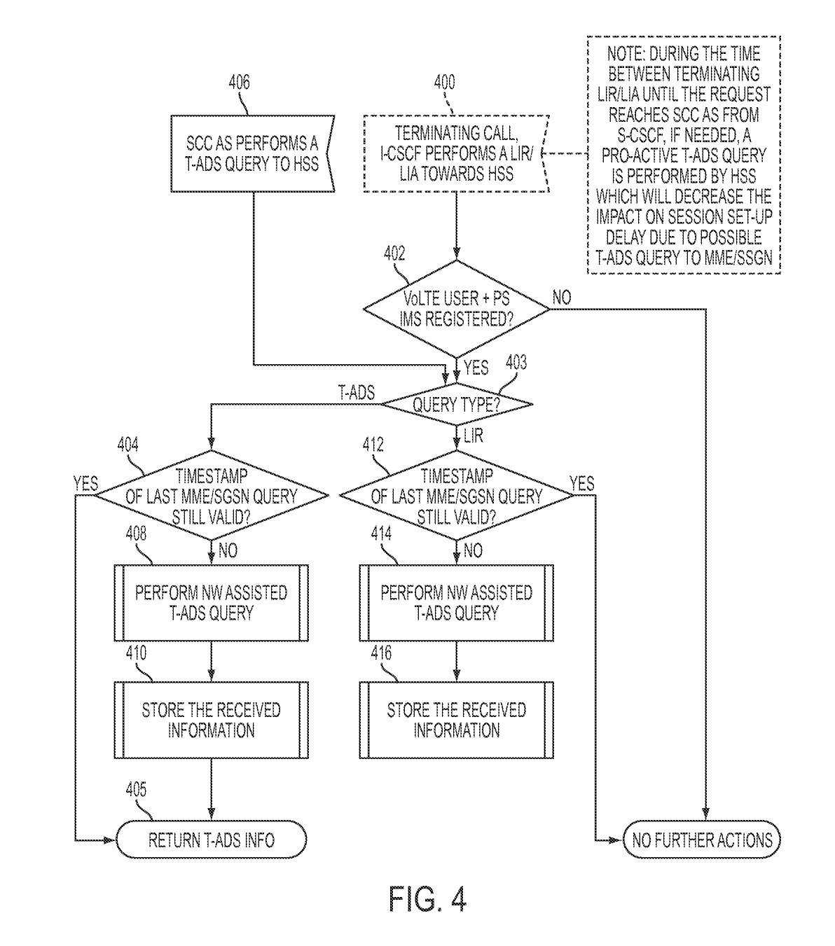

An embodiment associated with this pre-fetching operation is illustrated in FIG. 4. On reception of the standard Cx Location management procedures, the HSS 112 can fetch information, e.g., IMS voice support, RAT type to which the UE is attached (or cell ID information as described in more detail below) from the MME 108 or SGSN 110. This fetch is performed outside of the location management query and response dialog and, thus, does not affect the set-up time of the call. As shown, for example, in step 400, whenever a Cx User Location Query (i.e., Diameter: Location-Info-Request) is received from the I-CSCF 120 by the IMS HSS functional entity 112 and the VoLTE Subscriber is registered over PS by the UE at step 402, the IMS HSS 112 can request the HSS Evolved Packet System (EPS) functional entity to get T-ADS information (IMS voice support & RAT type to which the UE is attached) associated with this connection. Step 402 can, for example, be implemented by providing a flag in the HSS 112 which is set when a VoLTE subscriber is registered over PS by the UE 114 and then by the HSS 112 subsequently checking that flag in step 402 to determine that the location query is associated with a VoLTE subscription.

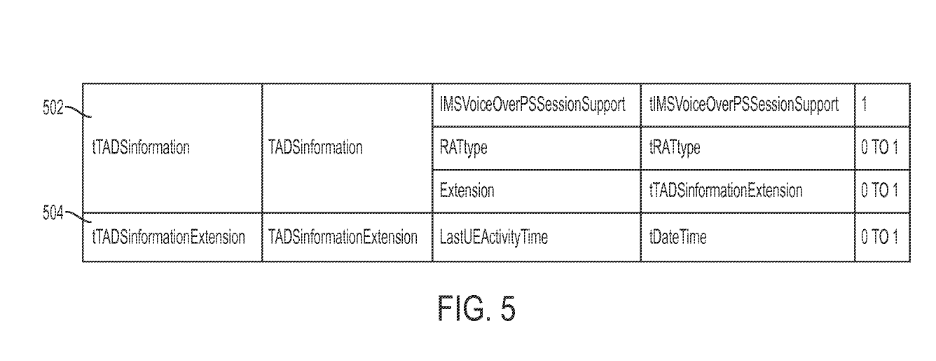

The HSS 112 can pre-emptively request this information whenever a location query message is received. Alternatively, and as illustrated in FIG. 4, the HSS 112 can cache (store) this information and re-use it as long as it is determined to still be valid. This embodiment has the benefit of further reducing signaling and delay. Various options can be used for determining if this information is still valid. For example, different paths can be taken depending on the query type as shown in step 403 when the request 406 is received. Following the T-ADS query type path, as shown by step 404, if the HSS 112 has previously cached T-ADS information for this subscriber, it can check to see if the timestamp associated with the previous query to the MME 108 or SGSN 110 indicates that the cached T-ADS information is still valid. According to an embodiment, the timestamps can be optimized to take into account the average time where the probability of the user staying in the same place (not moving) is higher than a certain value. Alternatively, a timer could be used. Regardless of the particular metric used to determine validity of the cached data, if it is valid, the flow can follow the “Yes” path from block 404 to be ready to return the T-ADS information (step 405) to the SCC AS 104. An example of the T-ADS information 502 prefetched by the HSS 112 is shown in FIG. 5 and includes whether or not IMS voice over PS session is supported (also known as VoLTE) and the RAT type that is serving the UE. Additionally, a T-ADS information extension field 504 can be included. More information regarding specific T-ADS information can be found in 3GPP TS 29.328, the disclosure of which is incorporated herein by reference.

Alternatively, if the HSS 112 checks its T-ADS information (IMS voice support, RAT type) timestamp and if, for example, a specific time has elapsed between the last time the HSS 112 got the requested information type, then it will fetch that information again and store it in memory as indicated by steps 408 and 410, respectively. This information can be retrieved while the I-CSCF contacts the S-CSCF and the S-CSCF contacts the SCC AS 104 as part of the overall terminating call setup process, which is described below.

Alternatively, following the LIR path, as shown by step 412, if the HSS 112 has previously cached T-ADS information for this subscriber, it can check to see if the timestamp associated with the previous query to the MME 108 or SGSN 110 indicates that the cached T-ADS information is still valid. If the timestamp is still valid no further action needs to be taken. Alternatively, if the HSS 112 checks its T-ADS information (IMS voice support, RAT type) timestamp and if, for example, a specific time has elapsed between the last time the HSS 112 got the requested information type, then it will fetch that information again and store it in memory as indicated by steps 414 and 416, respectively. This information can be retrieved while the I-CSCF contacts the S-CSCF and the S-CSCF contacts the SCC AS 104 as part of the overall terminating call setup process, which is described below. By the time the T-ADS 106, or an AS (e.g., for NetLoc as described below) queries HSS 112 via Sh for information, the HSS 112 should thus have that information cached by using this “off-line” pre-emptive fetching technique, thereby reducing connection setup time.

To put the pre-emptive fetching or pre-fetching process according to embodiments in perspective, consider again the overall processing of a terminating call in such a network. Typically, a terminating call is processed as follows:
1. I-CSCF-HSS 112 interaction and decision on which S-CSCF to be used for serving the user
2. I-CSCF sends the request to S-CSCF which performs Initial Filter Criteria (iFC) triggering
3. MMTel AS receives the call and performs terminating service execution.
4. There may be other Application Servers triggered by the S-CSCF.
5. SCC AS 104 is the last AS triggered. If the user is registered over PS an Sh T-ADS query to HSS 112 may be required. This in turn will trigger an information retrieval to MME or GGSN.
   However, according to the embodiments described here, the T-ADS query in step 5 above can instead be performed “off-line” as part of step 1 or in parallel to some of the other steps and the information cached by the HSS 112. This will ensure that the call set-up time will be improved compared to typical processing of a terminating call.

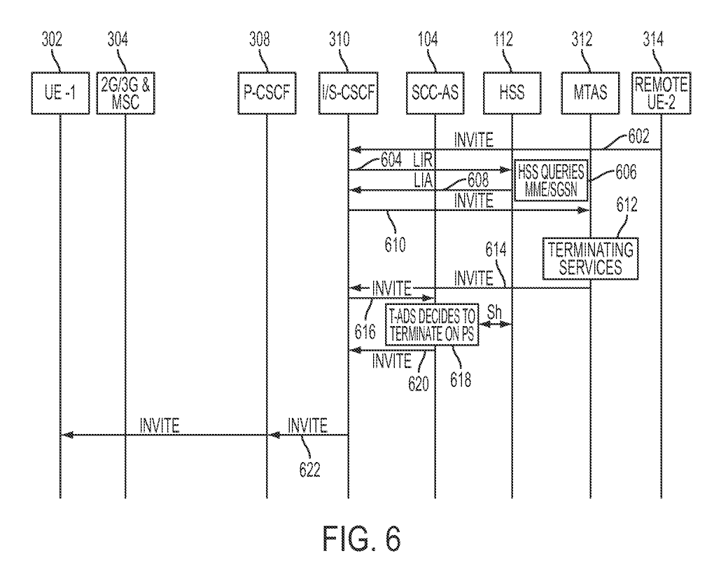

According to exemplary embodiments, as described above, prefetching of information can be performed to reduce delays in call set-up times. An example of the flow of signals in processing a terminating call in which prefetching is used is shown in FIG. 6. Initially remote UE2 318, transmits an invite message 602 which is received by an I-CSCF or an S-CSCF 310. The CSCF 310 then transmits a LIR message 318 to the HSS 112. Receipt of the LIR message 604 triggers the HSS 112 to perform the prefetching operation to obtain the desired information, e.g., by querying the MME/SGSN as shown in block 606. The HSS 112 then transmits a LIA message 608 back to the CSCF 310. The CSCF 310 then transmits an invite message 610 to the MT AS 312 which performs terminating services 612. The MT AS 312 then transmits an invite message 614 back to the CSCF 310 which in turn sends an invite message 616 to the SCC AS 104. The T-ADS decides to terminate on PS as shown in block 618 which triggers the SCC AS 104 to communicate with the HSS 112 over the Sh interface. The HSS 112 then transmits the desired information which was prefetched to the SCC AS 104 over the Sh reference. After receiving this information the SCC-AS 104 sends an invite message 620 to the CSCF 310. CSCF 310 then sends an invite message 622 to UE1 302 via a P-SCSF 308, a MSC 304 and the communication network, e.g., a 2G or a 3G communication network.

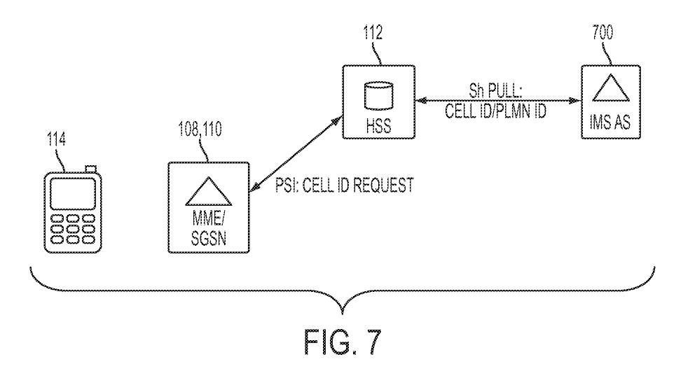

The present invention is not limited to pre-fetching of T-ADS related data by an HSS 112, but can include the pre-fetching of any data by the HSS 112 which can, for example, reduce service delays. Another example involves the previously mentioned NetLoc service. As outlined in the standards document 3GPP TS 23.842, there is a requirement for NetLoc to provide a Cell ID for: session establishment, session release, session modification, and in a SIP MESSAGE for Short Message Service (SMS). One of the proposed solutions for this requirement is a “pull-model”, which is conceptually illustrated in FIG. 7. Therein, when the Cell ID for a particular UE 114 is required, IMS requests it from the underlying system, e.g., the Cell-ID is available today from HSS 112. Thus an IMS AS 700 retrieves the Cell ID via the reference point Sh, by the HSS 112 obtaining the Cell ID via the reference points S6a/Gr to the EPC node MME 108 or to SGSN 110.

According to exemplary embodiments, when prefetching occurs in the NetLoc example, the HSS 112 transmits a request and receives a response which includes an attribute call “location Information”. The location Information can include the location of the served subscriber in the MSC/Visitor Location Register (VLR) if the requested domain is CS or the location of the served subscriber in the SGSN 110 if the requested domain is PS and either the requested node is SGSN 110 or the requested node is not present. Alternatively, the location Information can include the location of the served subscriber in the MME 108 if the requested domain is PS and the requested node is MME 110 or the locations of the served subscriber in the MME 108 and the SGSN 110 if the requested domain is PS and the requested nodes are MME 108 and SGSN 110. Location information for CS can include the following subordinate elements location number, service area ID, global cell ID, location area ID, geographical information, geodetic information, VLR number, MSC number, age of location information current location retrieved, user Closed Subscriber Group (CSG) information Evolved-Universal Mobile Telecom System Terrestrial Radio Access Network (E-UTRAN) cell global ID and tracking area ID. However, in some cases when the MSC receives the location information via SGs interface, the E-UTRAN Cell Global Identifier (ECGI) and Tracking Area Identify (TAI) are included, rather than location number, service area ID, global cell ID and location area ID. More information regarding NetLoc can be found in 3GPP TS 29.328.

While the pull method using HSS 112 may, in some regards, be a good mechanism for obtaining the Cell ID, e.g., since it does not impact existing standards, it may have the drawback that there will be a significant load increase in the HSS 112 and MME 108 (and session set-up time increase) if this process is performed, for example, for every Session Initiation Protocol (SIP) INVITE/MESSAGE. Thus, according to another embodiment, Cell ID information can be pre-fetched by HSS 112 to provide for NetLoc queries.

More specifically, for terminating NetLoc cases, whenever a Cx User Location Query (Diameter: Location-Info-Request) is received from I-CSCF 120 by the IMS HSS 112 functional entity and the VoLTE Subscriber is registered over PS by the UE (e.g., the HSS 112 checks the above-described flag), then the IMS HSS 112 will requests the HSS EPS functional entity to get NetLoc information (Cell ID). As in the T-ADS case above, the HSS EPS can check its NetLoc information (Cell ID) timestamp (timestamp optimization in this case can also consider terminating calls frequency). If a specific time has elapsed or a timer with a preset time amount has expired between the last time the HSS 112 obtained the requested information type, then the HSS 112 will fetch the Cell ID information again and cache it, and otherwise the HSS 112 will keep the information which was previously stored. This Cell ID information can be retrieved while the S-CSCF is storing the user information and analyzing initial filter criteria. When the Uniform Resource Identifier (URI) is received by the Application Server requiring NetLoc information, a request to retrieve NetLoc information via Sh is made, IMS HSS will request HSS EPS and HSS EPS will perform the same steps as aforementioned. As in the case of T-ADS 106 described above, the request for NetLoc information can be performed “off-line” using these embodiments, early in setup procedures, and the information cached by HSS 112. This will ensure that the call set-up time will be improved.

The foregoing embodiments provide various advantages and benefits, including, for example, decreasing the potentially restrictive call setup times associated with T-ADS and NetLoc use cases. Embodiments also provide advantages associated with: less load and resource usage on MME 108 & SGSN 110 for T-ADS and NetLoc, less load on the HSS 112 as it can cache T-ADS and NetLoc data, enhances and optimizes the existing T-ADS algorithm, and/or improves the load worries surrounding the selection of the pull method using HSS 112 in standards.

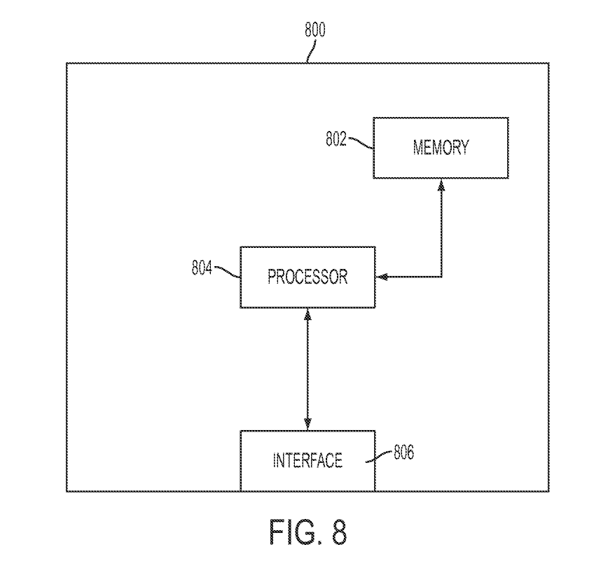

Some embodiments described above can be implemented in various radiocommunication nodes, e.g., the HSS 112. FIG. 8 depicts a generic node 800 which can implement the above-described embodiments, e.g., as an HSS 112. Therein, one or more processor(s) 802 can be configured to transmit and receive signals or messages via one or more interfaces 804. The processor(s) 802 can be configured to operate based upon, for example, software or program code stored in one or more memory devices 806. Additionally, memory 806 can be used to cache prefetched information, e.g., the VoLTE flag (also known as an IMS voice over PS flag).

According to an embodiment, the node 800 can be an HSS 112, and the processor(s) 802 can be configured to receive a location query message associated with the connection that is being setup, pre-fetch, in response to receipt of the location query message, information associated with the connection, and, subsequent to the pre-fetching, receive a request for the information.

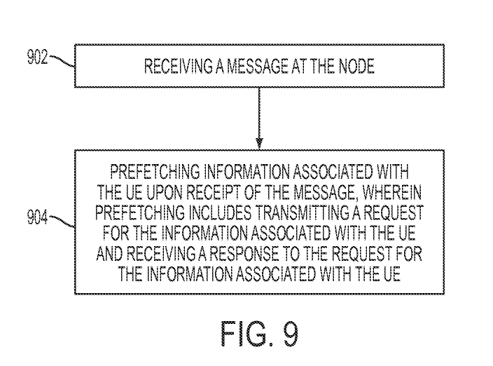

Utilizing the above-described exemplary systems according to exemplary embodiments, a method for gathering information associated with a UE at a node which is a part of a mobile communication network is shown in FIG. 9. The information associated with a UE can include information about the user, the UE, subscription information or any combination thereof. The method includes: receiving a message at the node at step 902; and prefetching information associated with the UE upon receipt of the message, wherein prefetching includes transmitting a request for the information associated with the UE and receiving a response to the request for the information associated with the UE at step 904.

The above-described embodiments are intended to be illustrative in all respects, rather than restrictive, of the present invention. All such variations and modifications are considered to be within the scope and spirit of the present invention. No element, act, or instruction used in the description of the present application should be construed as critical or essential to the invention unless explicitly described as such. Also, as used herein, the article “a” is intended to include one or more items.

1. A method for gathering information associated with a user equipment (UE) at a node which is a part of a mobile communication network, the method comprising:
receiving a message at the node; and
prefetching information associated with the UE upon receipt of the message, wherein prefetching includes transmitting a request for the information associated with the UE and receiving a response to the request for the information associated with the UE.

2. The method of claim 1, wherein the message is a lookup information request (LIR).

3. The method of claim 1, wherein the information associated with the UE is Terminating Access Domain Selection (T-ADS) information.

4. The method of claim 3, wherein the T-ADS information includes a flag indicating whether or not Internet Protocol Multimedia Subsystem (IMS) voice over Packet Switched (PS) is supported by the UE and the Radio Access Type (RAT) to which the UE is attached.

5. The method of claim 1, wherein the information associated with the UE is Network Provided Location (Netloc) information.

6. The method of claim 5, wherein the Netloc information includes a flag indicating whether or not Internet Protocol Multimedia Subsystem (IMS) voice over Packet Switched (PS) is supported by the UE.

7. The method of claim 1, wherein the received response to the request which includes at least a flag denoting whether or not Internet Protocol Multimedia Subsystem (IMS) voice over Packet Switched (PS) is supported by the UE is cached at the node.

8. The method of claim 7, further comprising:
checking the cache to determine if the flag for the UE is stored at the node;
determining, if the flag for the UE is currently stored at the node, the length of time the flag for the UE has been stored at the node; and
performing the step of prefetching information associated with the UE if there is either no flag for the UE currently stored at the node or if the length of time the flag for the UE has been stored at the node exceeds a predetermined amount of time.

9. The method of claim 8, wherein the predetermined amount of time is tracked by a timer.

10. The method of claim 1, wherein the node is a home subscriber server (HSS).

11. A communications node for gathering information associated with a user equipment (UE) which is a part of a mobile communication network, the communications node comprising:
an interface configured to receive a message at the node; and
a processor configured to prefetch information associated with the UE upon receipt of the message, wherein to prefetch includes transmitting a request for the information associated with the UE and receiving a response to the request for the information associated with the UE.

12. The communications node of claim 11, wherein the message is a lookup information request (LIR).

13. The communications node of claim 11, wherein the information associated with the UE is Terminating Access Domain Selection (T-ADS) information.

14. The communications node of claim 13, wherein the T-ADS information includes a flag indicating whether or not Internet Protocol Multimedia Subsystem (IMS) voice over Packet Switched (PS) is supported by the UE and the Radio Access Type (RAT) to which the UE is attached.

15. The communications node of claim 11, wherein the information associated with the UE is Network Provided Location (Netloc) information.

16. The communications node of claim 15, wherein the Netloc information includes a flag indicating whether or not Internet Protocol Multimedia Subsystem (IMS) voice over Packet Switched (PS) is supported by the UE.

17. The communications node of claim 11, wherein the received response to the request which includes at least a flag denoting whether or not Internet Protocol Multimedia Subsystem (IMS) voice over Packet Switched (PS) is supported by the UE is cached at the node.

18. The communications node of claim 17, further comprising:
the processor configured to check the cache to determine if the flag for the UE is stored at the node;
the processor configured to determine, if the flag for the UE is currently stored at the node, the length of time the flag for the UE has been stored at the node; and
the processor is configured to perform the step of prefetching information associated with the UE if there is either no flag for the UE currently stored at the node or if the length of time the flag for the UE has been stored at the node exceeds a predetermined amount of time.

19. The communications node of claim 18, wherein the predetermined amount of time is tracked by a timer.

20. The communications node of claim 11, wherein the node is a home subscriber server (HSS).
